(19) United States
(12) Patent Application Publication
(10) Pub. No.: US 2019/0016341 A1
(43) Pub. Date: Jan. 17, 2019

(54) ROADWAY REGULATION COMPLIANCE

(71) Applicant: HERE Global B.V., Eindhoven (NL)

(72) Inventor: Scott David Nelson, Grand Haven, MI (US)

(21) Appl. No.: 15/651,026

(22) Filed: Jul. 17, 2017

(51) Int. Cl. B60W 40/06; G08G 1/0967

(52) U.S. Cl. CPC B60W 40/06; B60W 2550/14; G08G 1/0967

(57) ABSTRACT

System and methods are provided for monitoring compliance with a regulation for a vehicle. A position of the vehicle and a roadway condition is acquired. One or more attributes of the vehicle are identified. Whether the regulation applies to the vehicle is determined based on the position, the roadway condition, and the one or more attributes. A command to perform an action relating to the regulation is transmitted. Vehicle data relating to the action is received from the vehicle. Compliance is determined based on the vehicle data.

### FIELD

The following disclosure relates to navigation devices or services.

### BACKGROUND

Regulations for trucks or large vehicles may be different than regulations for typical vehicles. Large vehicles may require additional or different regulations due to the weight or handling of the larger vehicles. In addition, the types and uses of large vehicles may vary from slightly larger two axle vehicles to enormous semi-tractor trailers to platoons of multiple vehicles. Each vehicle may have different dimensions and different weights. Accordingly, each vehicle may handle differently, for example, exhibit varying levels of traction control.

In order to provide efficient and effective safety measures, separate signage and enforcement may thus be required for different vehicles. Further, altering signage based on changing localized conditions may be difficult, particularly, for example in remote areas. Additionally, current enforcement mechanisms for compliance of regulations cannot handle granular ever-changing regulations.

### SUMMARY

In an embodiment, a method is provided for monitoring compliance with a regulation for a vehicle. A position of the vehicle and a roadway condition is acquired. One or more attributes of the vehicle are identified. Whether the regulation applies to the vehicle is determined based on the position, the roadway condition, and the one or more attributes. A command to perform an action relating to the regulation is transmitted. Vehicle data relating to the action is received from the vehicle. Compliance is determined based on the vehicle data.

In an embodiment, a method is provided for monitoring compliance with a roadway regulation. Vehicle data is received relating to operation of a vehicle and a location of the vehicle. A roadway condition is identified for the location. The vehicle is determined to be subject to the roadway regulation based on the roadway condition and the location of the vehicle. The vehicle is determined to not be in compliance with the roadway regulation based on the first vehicle data. An alert is transmitted to the vehicle.

In an embodiment, an apparatus is provided for determining compliance with a regulation. The apparatus includes positional circuitry, a geographic database, a vehicle sensor, a transceiver, and a processor. The positional circuitry is configured to determine a location of a vehicle. The geographic database is configured to store data related to a roadway condition for the location. The vehicle sensor is configured to identify one or more attributes of the vehicle. The transceiver is configured to receive a regulation from an authority and transmit a compliance message to the authority. The processor is configured to determine if the regulation applies to the vehicle based on the location, roadway condition, and the one or more attributes, perform an action to comply with the regulation, and generate the compliance message.

### BRIEF DESCRIPTION OF THE DRAWINGS

Exemplary embodiments of the present invention are described herein with reference to the following drawings.

FIG. 1 illustrates an example system for determining compliance with roadway regulations.

FIG. 2 illustrates an example workflow for determining compliance with roadway regulations.

FIG. 3 illustrates an example map of a geographic region.

FIG. 4 illustrates an example geographic database.

FIG. 5 illustrates an example geographic database.

FIG. 6 illustrates an example server of the mapping system of claim 1.

FIG. 7 illustrates an example workflow for determining compliance with roadway regulations.

FIG. 8 depicts an example geographic map of regulation coverage.

FIG. 9 illustrates an example device of the mapping system of claim 1.

FIG. 10 illustrates an example workflow for determining compliance with roadway regulations.

### DETAILED DESCRIPTION

Embodiments described herein provide systems and methods for alerts, mitigation, and compliance with roadway conditions. Data describing a vehicle and a roadway condition is acquired. A mitigating action is identified for the roadway condition based on the data for the vehicle. The mitigating action is transmitting to the vehicle. Compliance with the mitigating action is monitored based on data received from the vehicle.

A collection of standards for operating a vehicle exist for various locations. In the United States, for example, multiple governmental agencies may regulate a single stretch of roadway including federal, state, county, and city agencies among others. The transit from one set of regulations to another may cause issues for vehicles (for example, semi-tractor trailers) that may be driven across multiple jurisdictions while carrying varying loads. Regulations may also not be explicitly defined. California, for example, does not have any specific dates when vehicles are required to carry chains. California relies on posted signs, which may be difficult to change or may not provide accurate or up to date information. In California, when the road is posted with a sign requiring chains, all heavy-duty vehicles (over 6,500 pounds gross weight) must be equipped with chains mounted on the tires in order to proceed. To complicate regulations further, other exceptions may apply depending on the vehicle and condition. For example, depending on the severity of road conditions, some vehicles (passenger cars, 4-wheel drive vehicles with snow tires) may not be required to install chains. If a truck was to transit between California and Nevada, different regulations would then apply. Nevada, for example, requires vehicles>10,000 lbs. to chain when posted.

Further, the lack of uniformity in the size and handling of vehicles resulting in that a simple binary determining factor (such as weight) does not appropriately predict safe operations for hazardous events. A regulation that covers all vehicles above a certain attribute (for example, weight) does not take into consideration the ability of specific vehicles to navigate the roadway. A modern trucking system may be able to handle more extreme hazards than an older trucking system. Advances in breaking and sensors, for example, may allow a vehicle to traverse more extreme roadways without adjusting the tire or speed of the vehicle. Different operating companies or users may further have different guidelines that may be stricter than regulation. The hodgepodge of regulations, the variance in vehicles, and the different operating procedures all create inefficiencies when dealing in particular with large vehicle hazards. The ability to define how regulations apply on a vehicle by vehicle may allow for more efficient and safe travel. Granularly defined regulations, however, may have issues with compliance.

Granular regulations may vary and may apply to similar vehicles differently depending on multiple factors such as weight, driving history, type of load, distance traveled etc. Current systems of compliance may rely on the driver to self-regulate or comply with truck screening points. At truck screening points, all trucks may be required to stop and show that they have complied or can comply with all regulations in force. Forcing every vehicle to stop is inefficient and causes delays. Alternatively, authorities may be tasked with enforcing compliance. Binary or simple regulations may be easy to enforce, but granular and specific regulations may require too much effort. In one example, current tire chain law activations are based upon fairly static rules and principles—all or nothing based upon road surface condition. Compliance may be detected easily by a binary determination of whether the regulations are in force. With granular regulations that specify multiple factors, compliance with chain laws may be much more difficult as enforcement requires that the authorities determine multiple attributes or factors before determining compliance or non-compliance.

Embodiments provide an automated method for identifying, alerting, mitigating, and complying with large vehicle hazards. Data from a vehicle is combined with data from a geographic database to determine if a specific vehicle is affected by a hazard. A mitigation action is identified and transmitted to the vehicle. Compliance with the mitigation action is monitored. If compliance is not achieved, further alerting or reporting actions may be provided.

In one embodiment, tire chain law activation and activation of other tire and in-motion surface preparation technologies may become activated based upon algorithmic and conditions, e.g., based upon vehicle type, weight, hazmat or load types, route, surface condition, external surface treatment status, installed tire types, type of tire preparations (e.g. chain, stud, spike), and onboard surface/tire treatment capabilities. With a granular and specific approach to regulating and compliance, some vehicles may be permanently compliant and never need to pull off to the side of the road or adjust operation of the vehicle. Other vehicles may otherwise ignore actions that under a binary system the vehicles would have to comply with. Additionally, a driver or vehicle system may provide acknowledgement that a particular action specific to the condition and the vehicle has been performed. Enforcement may be done automatically on a vehicle to vehicle basis with specific regulations applied to each vehicle based on the attributes and conditions present at that time without requiring human intervention.

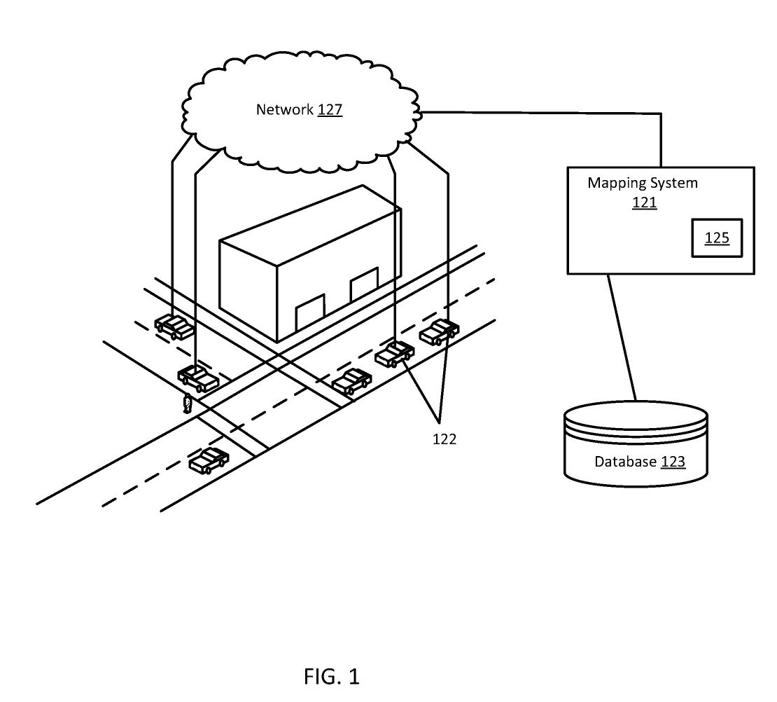

FIG. 1 depicts a system for alerting and complying with large vehicle hazards. The system includes one or more devices 122, a network 127, and a mapping system 121. The mapping system 121 may include or may be connected to a database 123 (also referred to as a geographic database or map database). The mapping system 121 may include one or more servers 125. Additional, different, or fewer components may be included.

Large vehicles may herein refer to vehicles such as commercial motor vehicles (CMV). CMVs may include trucks, straight trucks, busses, semitrailers, transporters, truck tractor semitrailers configurations, truck tractor semitrailer trailer configurations, and other commercial vehicles. Other large vehicles may include non-commercial vehicles such as recreational vehicles, military or farm equipment, instruments of husbandry, road construction or maintenance machinery, and emergency apparatus, including police and fire emergency equipment. A large vehicle may refer to a vehicle that has attributes or handles outside the normal bounds of a typical automobile, e.g. excessive length, width, height, weight, additional axles among other attributes. Certain pickup trucks, vans, or passenger cars may qualify as large vehicles due to their weight. For example, medium trucks over 14,000 pounds may be considered large vehicles.

The system includes one or more devices 122. The one or more devices may include probe devices, probe sensors, or other devices 122 such as personal navigation devices 122 or connected vehicles. The mapping system 121 may communicate with the devices 122 through the network 127. The mapping system 121 may also receive data from one or more systems or services that may be used to identify the status of a vehicle or roadway conditions. The device 122 may be a navigation system built into the vehicle and configured to monitor the status of the vehicle. The device 122 may acquire and store attributes about the vehicle. For example, the device 122 may identify a type of load that is being carried, the weight of the vehicle, the dimensions of the vehicle, the handling capabilities of the vehicle, sensor options in the vehicle, installed tire types, type of tire preparations (chain/stud/spike/etc.), and onboard surface/tire treatment capabilities, or vehicle operation history among other attributes. The devices 122 may also be integrated in or with a vehicle. The devices 122 may include mobile phones running specialized applications that collect location data as the devices 122 are carried by persons or things traveling the roadway system. The devices 122 may be configured to collect and transmit data including the status of a vehicle. The devices 122 may be configured to monitor conditions in the vicinity of the vehicle and track compliance with any pertinent regulation. The devices 122 may be configured to provide guidance for a user or vehicle.

The mapping system 121 and devices 122 are connected to the network 127. The devices 122 may receive or transmit data through the network 127. The mapping system 121 may receive or transmit data through the network 127. The mapping system 121 may also transmit paths, routes, regulation, or compliance data through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMax (Worldwide Interoperability for Microwave Access) network, DSRC (otherwise known as WAVE, ITS-G5, or 802.11p and future generations thereof), a 5G wireless network, or wireless short-range network. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols.

The mapping system 121 may include multiple servers 125, workstations, databases, and other machines connected together and maintained by a map developer. The mapping system 121 may be configured to determine when a location is affected by a hazard and if a regulation should be applied to a vehicle. The mapping system 121 may be configured to determine if the vehicle has complied with the regulation. The mapping system 121 may also be configured to generate routes or paths between two points (nodes) on a stored map. The mapping system 121 may be configured to provide up to date information and maps to external geographic databases or mapping applications. The mapping system 121 may be configured to encode or decode map or geographic data. Regulations for operating a vehicle may be stored by the mapping system 121 in the geographic database 123 as link, segment, or node attributes. Regulations may be stored by the mapping system 121 using geographic coordinates such as latitude and longitude. Hazardous events may be identified by the mapping system 121 and stored in the geographic database 123. The mapping system 121 may acquire roadway conditions though one or more devices 122. The roadway conditions may indicate that a condition exists for a location.

The mapping system 121 may include one or more server(s) 125. A server 125 may be a host for a website or web service such as a mapping service and/or a navigation service. The mapping service may provide maps generated from the geographic data of the database 123, and the navigation service may generate routing or other directions from the geographic data of the database 123. The mapping service may also provide information generated from attribute data included in the database 123. The server 125 may also provide historical, future, recent or current traffic conditions for the links, segments, paths, or routes using historical, recent, or real time collected data. The server 125 may be configured to analyze roadway conditions and attributes of a vehicle and determine if a regulation applies and/or if a mitigating action should be taken. The server 125 may be configured to monitor compliance with an applicable regulation or mitigating action.

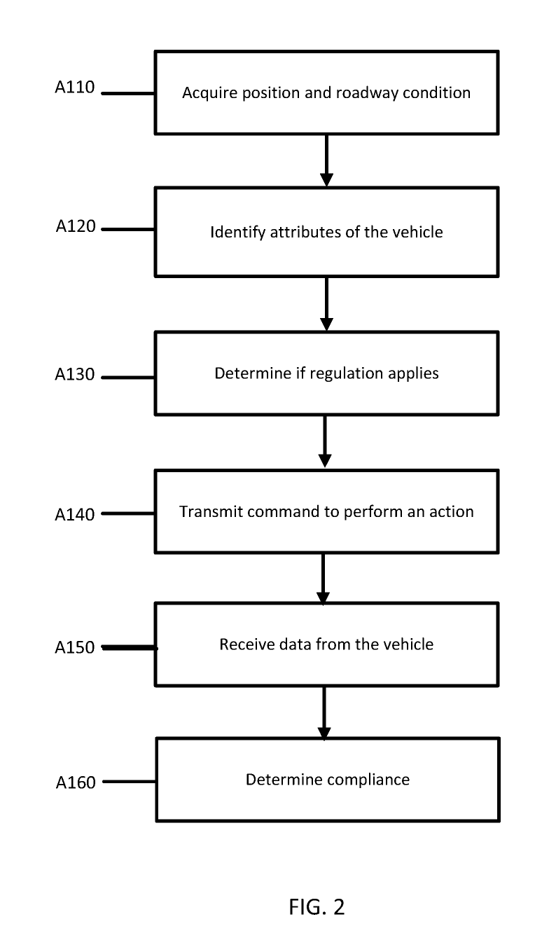

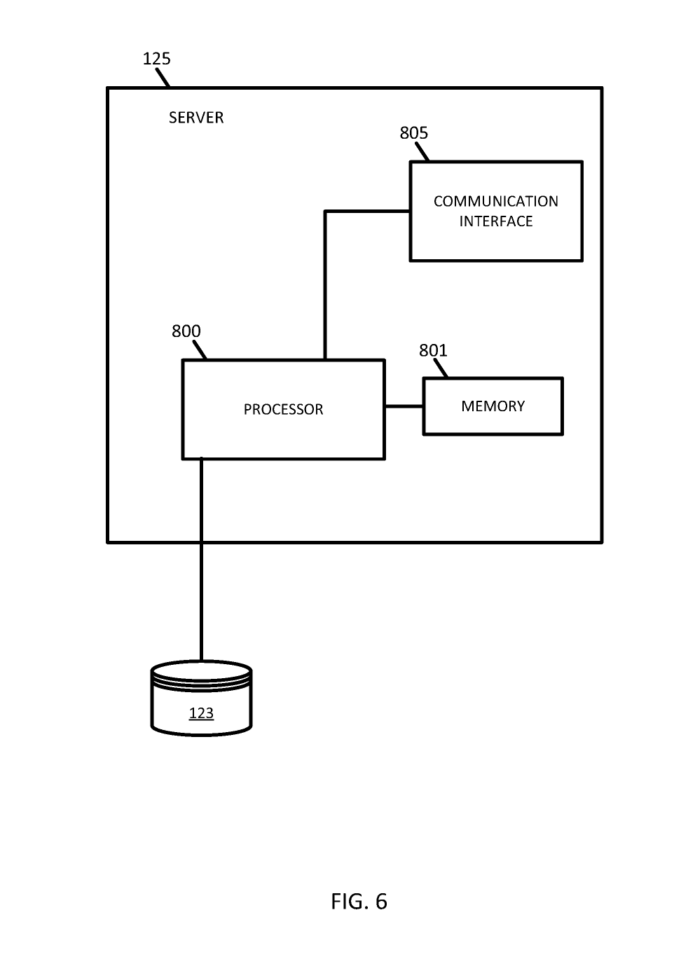

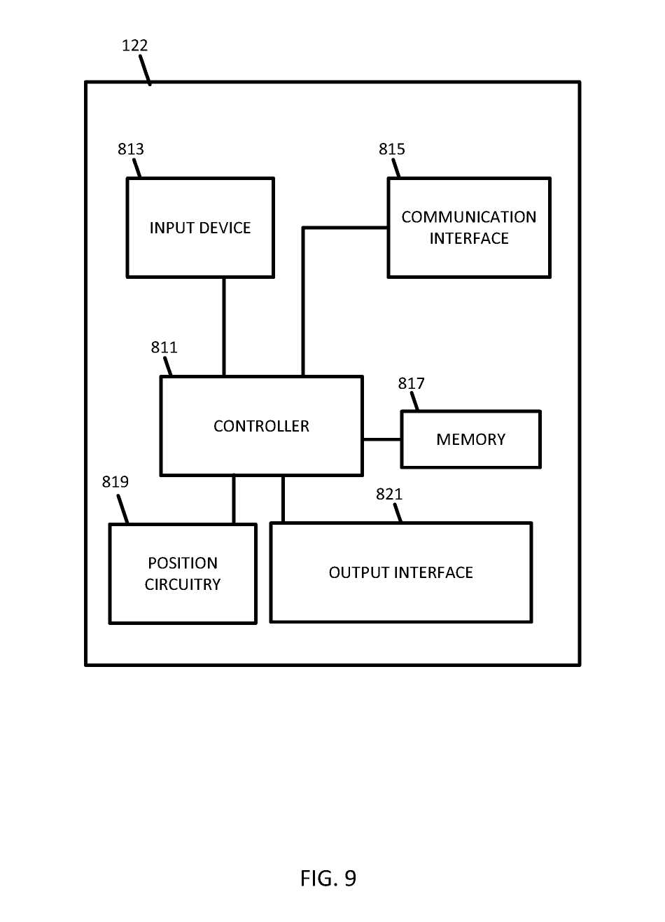

FIG. 2 illustrates an example flow chart for providing mitigation and compliance with regulations. As presented in the following sections, the acts may be performed using any combination of the components indicated in FIG. 1, FIG. 6, or FIG. 9. The following acts may be performed by the server 125, the device 122, the mapping system 121, or a combination thereof. Additional, different, or fewer acts may be provided. The acts are performed in the order shown or other orders. The acts may also be repeated. Certain acts may be skipped.

As referred to herein, a regulation may be a rule or directive made and maintained by an authority. The authority may be a governmental agency or other agency that is empowered to give orders, make decisions, or enforce obedience. For example, a trucking company or shipping company may be considered an authority even though any rules prorogated and enforced by the company may not apply to the general public.

At act A110, a position of the vehicle and a roadway condition is acquired. The mapping system 121 may receive or request and receive data from the one or more devices. The one or more devices may include a positioning system that may provide location data. The location data may include, for example, geographic coordinates such as latitude and longitude or positional data relating to a current roadway position such as the segment or node that the device or vehicle is on. The mapping system 121 may receive a future position of the vehicle, for example when a route is entered into the device or a route is requested from the mapping system 121. The position of the vehicle may correspond to geographic data stored in the geographic database 123.

The roadway condition may be acquired from data from the vehicle. The roadway condition may be derived from one or more reports from devices or probes other than the vehicle. For example, real-time sensing of traction conditions on the roadway may not be performed solely but the subject vehicle, but may be acquired via community-based sensing such as a vehicle sensing network, and including state fleets and heavy trucking fleets, both for better coverage and vehicle-class based differentiation of road traction conditions. Roadway conditions may be acquired and updated as additional reports from devices or probes are received. Example roadway conditions may include environmental conditions, a road surface type, a road surface temperature, visibility, precipitation (and amount), and light conditions among others. Roadway conditions may cover regions or individual nodes or road segments. Data for the roadway conditions may be stored in a geographic database 123.

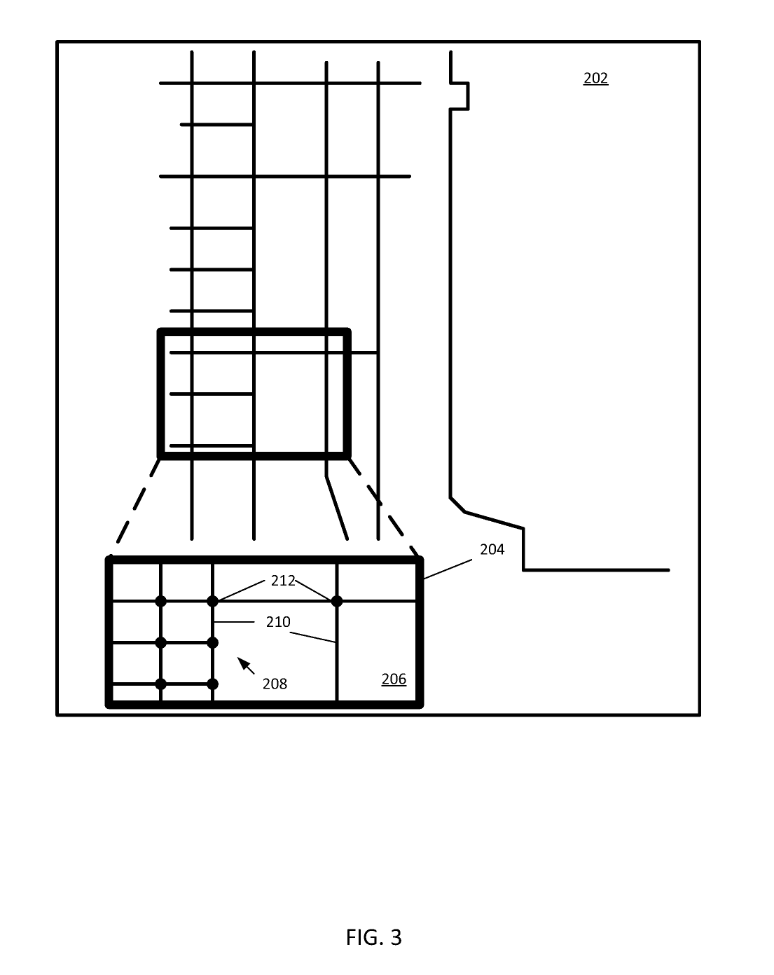

The mapping system 121 includes the geographic database 123. In order to provide navigation related features and functions to the end user, the mapping system 121 uses the geographic database 123. The mapping system 121 may use data from the geographic database 123 to determine applicable regulations and monitor compliance. The geographic database 123 includes information about one or more geographic regions. FIG. 3 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 3 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Each road segment 210 is shown to have associated with it two nodes 212; one node represents the point at one end of the road segment and the other node represents the point at the other end of the road segment. The node 212 at either end of a road segment 210 may correspond to a location at which the road meets another road, i.e., an intersection, or where the road dead ends.

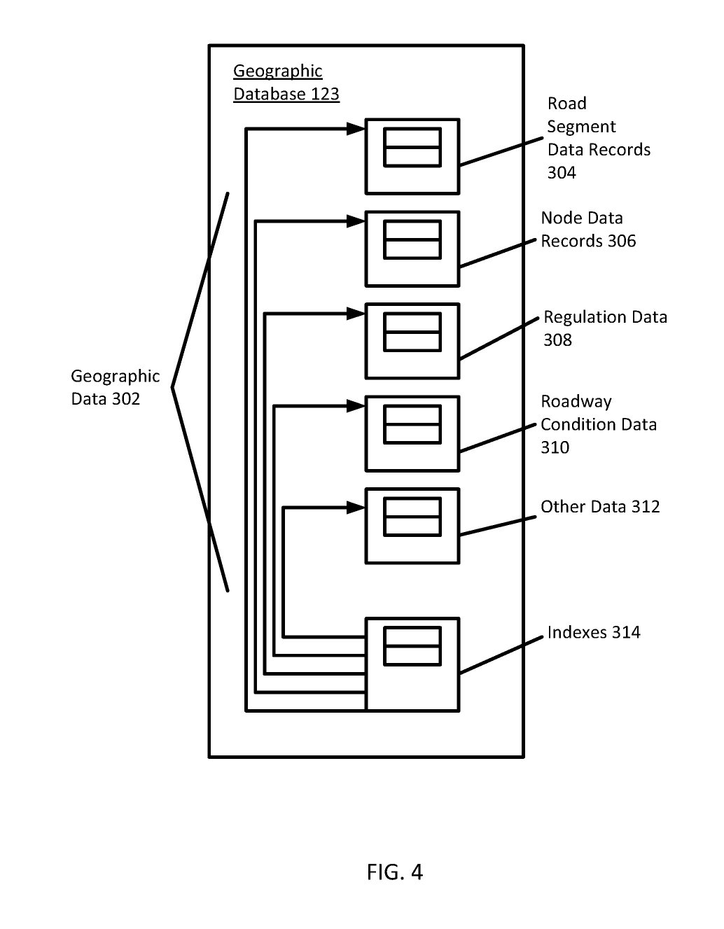

As depicted in FIG. 4, in one embodiment, the geographic database 123 contains geographic data 302 that represents some of the geographic features in the geographic region 202 depicted in FIG. 3. The data 302 contained in the geographic database 123 may include data that represent the road network 208. In FIG. 4, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include other kinds of data 308-312. The other kinds of data 312 may represent other kinds of geographic features. The other kinds of data may include point of interest data. For example, the point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The geographic database 123 may include regulation data 308 for the roadway network. For example, the regulatory data 308 may include one or more regulations that apply to a vehicle on the roadway network. The regulatory data may be organized by a region or area that includes one or more nodes or segments. The regulatory data may be cross referenced with roadway condition data 310 for when the regulations apply. A road segment with a steep grade may have a lower threshold for when a regulation take effect than a road segment with a flat grade. Contiguous road segments may have the same or similar regulation applied when conditions are met on one segment. Two contiguous segments, one steep, one flat may both have a regulation applied in order to provide an easy to comply with standard. Alternatively, for a regulation or mitigation activity such as automatic stud or tire chain (collectively and generally, “traction apparatus”) deployment on a tire, the regulations may be different for two contiguous segments. Automatic traction apparatus deployment may be applied differently for each segment for different vehicles efficiently without requiring a stop. The geographic database 123 may include roadway condition data 310 relating to a past, current, or future conditions of a roadway network. The geographic database 123 may store historical data relating to roadway conditions and compliance with regulations.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304. As another example, the indexes 314 may relate regulations in the other data records 312 with a road segment in the segment data records 304 or a geographic coordinate. The indexes 314 may store and relate regulations with jurisdictions and related road segments.

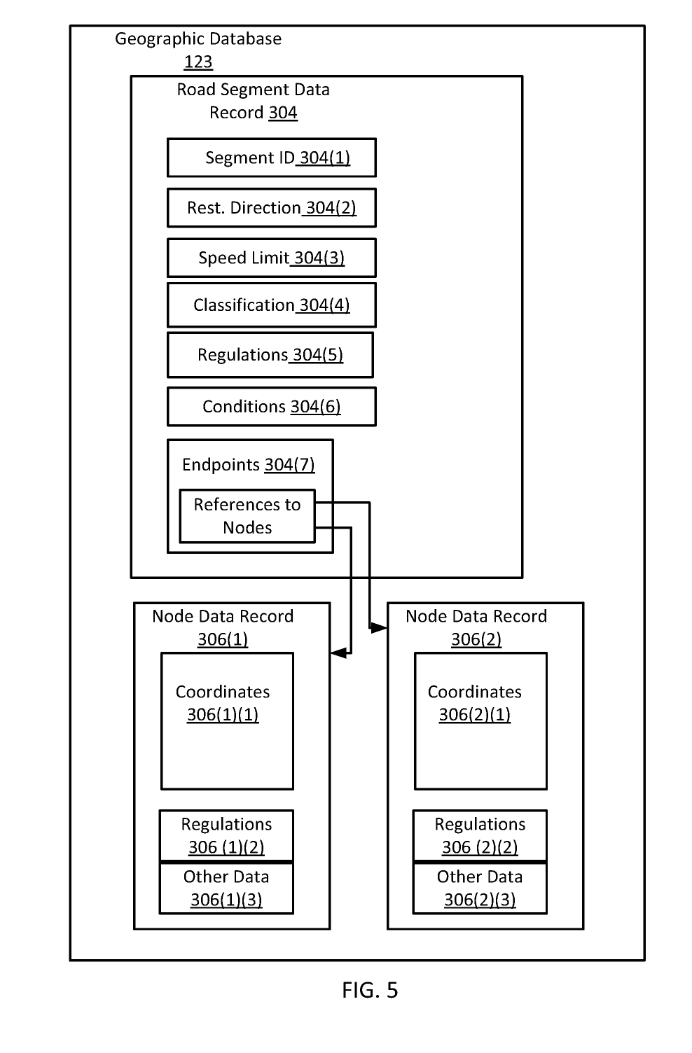

FIG. 5 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with it information (such as “attributes”, “fields”, etc.) that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include classification data 304(4) indicating whether the represented road segment is part of a controlled access road (such as an expressway), a ramp to a controlled access road, a bridge, a tunnel, a toll road, a ferry, and so on.

The road segment data record 304 may include data relating to when a regulation applies (e.g. under what conditions). For example, a road segment data record may include a regulation that applies when there is a certain level of snow in the region. The road segment data record may include an algorithm or equation to determine if the regulation applies to a specific vehicle. For example, the algorithm may consider the weight of the vehicle, the amount of snow, the amount of traffic, the speed of the vehicle, the tire attributes, and the grade of the road. The road segment data records 304 may describe features such as the regulation data 304(5) or compliance data 304(6). The regulation data and compliance data may be stored in relation to a link/segment 304, a node 306, a strand of links, an area, or a region. The geographic database 123 may store information or settings for compliance actions such as alerts. The geographic database 123 may be coupled to a display. The display may be configured to display the roadway network and alerts using different colors or schemes. The geographic database 123 may provide different display information depending on, for example, the severity of the hazardous event and the urgency of compliance with a regulation. An alert to lower the speed of a vehicle may be urgent, while an alert to install a traction apparatus may be transmitted in advance in order to give the driver or vehicle time to pull off the road and perform the installation.

The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment.

The road segment data record 304 may also include or be associated with other data 304(7) that refer to various other attributes of the represented road segment. The various attributes associated with a road segment may be included in a single road segment record, or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is identified, the street address ranges along the represented road segment, and so on.

FIG. 5 also shows some of the components of a node data record 306 that may be contained in the geographic database 123. Each of the node data records 306 may have associated information (such as “attributes”, “fields”, etc.) that allows identification of the road segment(s) that connect to it and/or its geographic position (e.g., its latitude and longitude coordinates). For the embodiment shown in FIG. 5, the node data records 306(1) and 306(2) include the latitude and longitude coordinates 306(1)(1) and 306(2)(1) for their node, and regulation data 306 (1)(2) and 306(2)(2) specific to the node. Regulation data may be stored or indexed by road segments or node and may be cross referenced. The node data records 306(1) and 306(2) may also include other data 306(1)(3) and 306(2)(3) that refer to various other attributes of the nodes such as current conditions or for example, the current regulations active within a range of the node.

The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Remote sensing, such as aerial or satellite photography, may be used. The database 123 is connected to the server 125.

The geographic database 123 and the data stored within the geographic database 123 may be licensed or delivered on-demand. Other navigational services or traffic server providers may access the traffic data and the regulatory data stored in the geographic database 123. Data including regulation data may be broadcast as a service.

Referring back to FIG. 2, at act A120, one or more attributes of the vehicle are identified. The at least one attribute may include data describing the vehicle. The one or more attributes may include data relating to the operation of the vehicle such as the dimensions or weight of the vehicle, the model of the vehicle, the operational capabilities (braking/velocity/acceleration etc.), and other values or data that describe the vehicle in question. The one or more attributes may further include data relating to the current operation of the vehicle. In an embodiment, each vehicle may be assigned a unique identifier that specifies the attributes of the vehicle. Vehicle loads may be identified. Attributes of the load, for example, weight, dimensions, or hazardous properties may be stored in a database and accessed by the mapping system 121.

The one or more attributes may be stored in a database at the mapping system 121. The one or more attributes may be acquired from a trucking company. The one or more attributes may be acquired from a trucking station. For example, vehicles may be required to provide dimensions or weights at stations along the roadway. The information collected may be provided to the mapping system 121 over the network. Attributes of the vehicle may be collected from other vehicles on the roadway network. For example, other vehicles on the roadway with exterior sensors may be able to determine the dimensions of the vehicle in question.

At act A130, the mapping system 121 determines if the regulation applies to the vehicle based on the position of the vehicle, roadway conditions at the position, and the one or more attributes. Regulations may include one or more factors in order to be applicable. The factors may relate to the time of day, the roadway conditions, the attributes of the vehicle, and other factors. A regulation may always be in force for certain vehicles. A regulation may never be in force for certain vehicles. Regulations may be updated or changed by an authority. Regulations may be updated automatically based on feedback mechanisms resulting from monitoring compliance with the regulation. Whether or not a regulation applies and if an action should be taken may be determined on a vehicle to vehicle basis or by a grouping of similar vehicles or common characteristics.

At act A140, a command to perform an action related to the regulation is transmitted to the vehicle. The action may be for the vehicle to take a physical action, such as swapping out tires or installing a traction apparatus. The action may be to alter the speed of the vehicle. The action may be to change the operation of sensors. The action may be combination of actions such as changing to snow tires and slowing down to a predetermined speed. Other commands to perform actions may be transmitted. The command to perform an action may be transmitted using text, images, or sound. Alternatively, the command may be a computer implemented command and may be decoded by the device or vehicle. For example, in an autonomous vehicle, there may be no need for a visual or auditory alert. The autonomous vehicle may receive the command to perform and action and then implement the action.

Whether or not a regulation applies and the action is transmitted may be determined as a function of an algorithm, a database, or a lookup table. For example, on a roadway segment, the combination of a wet roadway (roadway condition), a heavy vehicle (vehicle attribute), and low visibility (roadway conditions) may trigger a regulation that a maximum speed be lowered. However, for the same roadway segment, the maximum speed may not be lowered for a vehicle that that has better sensors or better traction. The action may be determined based on historical data for similar scenarios. The action may be defined by a governmental agency or other authority. Different authorities may require certain rules based on conditions and types of vehicles.

Specific scenarios are described below. Additional inputs may be used to determine whether the regulation applies and what action is to be taken. Regulations and actions may be designated mandatory or voluntary. The actions describe below may be checked for compliance at act A160 below.

The system may include truck speed limit alerting. Speed limits may be assigned specifically for trucks. Speed limits may be set by regulatory agencies or defined by a company. The speed limits may be calculated as a function of the attributes of the vehicle and the roadway conditions. For example, the weight, stopping distance, and traction of the vehicle may be compared with the roadway surface conditions, visibility, and amount of current traffic to set a safe speed limit. For autonomous or semi-autonomous vehicles, the speed limit alerts may require the vehicle to take evasive action or automatic mitigation such as lowering the vehicle speed immediately.

The system may include tire chain law alerting. Tire chain regulations exist for multiple jurisdictions. Each authority or regulatory agency may have different triggers for when a traction apparatus alert goes into effect. With a granular approach, jurisdictions may draft tire chain regulations so that they only apply to vehicles that need a traction apparatus for specific conditions. Compliance may further be simplified by the system. Additional information may be included for tire chain regulations including the location of truck chain stations or truck parking for chain installation dynamic or predictive parking availability at the truck chain stations. For a granular approach, tire chain regulations may be combined with automatic deployment of on-vehicle or in-tire chains, spikes, studs, or de-icing mitigation prior to or in addition to requiring a traction apparatus on a vehicle. The regulation and compliance may be ramped up as conditions worsen. Half measures such as studs or lowering of the speed limit may further be implemented preemptively without forcing vehicles to stop and apply a traction apparatus.

Low Bridge ahead alert. Bridges or overhead structures may be identified in the geographic database 123 or through the use of probe reports. Ice or snow built up on the surface of a roadway may affect a clearance height of a bridge or overhead structure. The adjusted clearance height may be factored into an alert, given sufficient knowledge of the road surface condition. Attributes of the vehicle and vehicle load may be identified in order to determine if there is a chance of an accident. If there is an issue, the system may automatically prompt a re-route. Optionally, for autonomous, or semi-autonomous vehicle, the system may transmit a command to take an evasive action or automatic mitigation such as activate hazard indicators and pull over to side of road.

The system may include narrow road or passage alerts. Similar to low bridge alerts, narrow passages may be identified in the geographic database 123 or through the use of probe reports. Attributes of the vehicle such as turning radius or width may be acquired. Different vehicles may have different maneuverability. A longer vehicle may not be able to make a turn or avoid an obstacle whereas a shorter vehicle (or load) may proceed. For autonomous, or semi-autonomous vehicle, the system may transmit a command to take an evasive action or automatic mitigation such as activate hazard indicators and pull over to side of road.

The system may include truck restriction alerts. Certain road segments may prohibit certain types of vehicles based on weight, noise, or load. The restrictions for a road segment may be designed to be flexible depending on, for example, the amount of traffic or the weather conditions. Restrictions may be applied only when needed. Up to date restrictions and compliance may be monitored by the system. Compliance with varying restrictions may be verified without requiring the authorities to make individual determinations for each vehicle.

The system may include hazmat restriction ahead alerts. For certain roads or routes if the current vehicle is known to have a hazardous load (e.g., by driver setting or pre-trip checklist in the onboard system or application or driver's log, type of trailer or load detection, or connected fleet system manifest) the system may provide alerts on the approaching hazmat restriction. Similar to the truck restriction, the hazmat restrictions may be adjusted by an agency based on traffic conditions or other non-pre-determined factors so that the restrictions are only applied when necessary.

The system may include railroad crossing alerts. Rail road crossing or road blockages may be identified to alert trucks or other vehicles where trailers can be stuck on the train trestle. Extra-urgent alert may be generated for train approaching for vehicles with slow acceleration or longer loads.

The system may include weight restriction alerts. For certain routes, roads, and bridges, there may be weight restrictions. Classical weight restrictions may be defined by a gross weight. With a granular approach, the attributes of the vehicle may be taken into consideration. For example, a specific vehicle may spread weight over an additional area. Specific settings for vehicle-specific, or load-specific alerting may be based upon estimated weight, or actual sensed weight (as input by driver, or detected by vehicle, input by (connected) fleet management system, or sensed by infrastructure weigh station.

The system may include energy related alerts. The energy needs or energy profiles of a vehicle may be stored and regulated. Platoons of vehicles that share energy or mutually benefit from energy characteristics of a route or corridor may be grouped in a mutually beneficial manner. Energy usage for individual vehicles or groups of vehicles may be monitored and regulated.

At act A150, vehicle data is received from the vehicle relating to the action. The vehicle data may include data that indicates compliance. The compliance data may be an affirmative response from the vehicle, truck, or operator that the action has been taken. The compliance data may be data relating to the operation of the vehicle from which compliance may be determined. The one or more devices 122 may acquire data relating to the operation of the vehicle by monitoring sensors in the vehicle. For example, the speed, acceleration, position, and braking systems among other systems may be monitored. Other data such as steering data, network connection data, object recognition, lane recognition, and environmental data may be monitored.

Compliance with an action to install a traction apparatus may include position data such as by detecting that the vehicle stopped at a location identified as a tire chain installation station for a certain amount of time. Alternatively, the one or more devices may prompt an operator to verify that the traction apparatus were installed. Other actions, such as automatic stud deployment or decrease speed may be implemented directly without operator action and may provide acknowledgement data directly to the one or more devices or mapping system 121.

In an embodiment, compliance data may be received from a third party, for example a different vehicle or roadside sensor. A neighboring vehicle may have exterior sensors that may be able to determine if the vehicle has implemented the action. Roadside sensors such as video sensors may likewise be able to determine if the vehicle has implemented the action. Additionally, third party data may be used to verify or contradict the vehicle data. In an example, where the vehicle data is an affirmative input by an operator, third party data (for example, a roadside sensor) may determine if the operator did not perform the action or if a malfunction has occurred. An affirmative input by an operator may not be a reliable indicator of compliance and may require confirmation by a third party to be valid as compliance.

At act A160, the processor 800 determines, based on the vehicle data, if the action has been complied with. Various levels of compliance may be monitored. For example, certain actions may be required (e.g. regulated by law). Certain actions may be best practice but not mandatory. Certain actions may be left up the operator of the vehicle. The compliance or non-compliance with all actions may be recorded and stored at the mapping system 121. Partial or full compliance with an action may be determined. Certain regulation or action may involve multiple steps. Compliance with each of the steps may be monitored.

Compliance with an action may take a period of time depending on the action. A command to reduce speed may be immediate whereas a command to install a traction apparatus may require a stop. Certain actions may require multiple steps or actions that may take time to implement.

Compliance may be estimated from the vehicle data. In the example of tire chain installation, compliance may be estimated by tracking the vehicle's position after the message has been transmitted. If, for example, the vehicle pulled off into a designated area for installing a traction apparatus, spent a period of time in the area, and then resumed the route, the system may determine that a traction apparatus was installed and that the vehicle is in compliance.

In the event that compliance with an action is not verified, further action may be taken by the mapping system 121. Each action may have a secondary action that may be performed if the initial action is not complied with. An alert message may be sent to the vehicle or a communications device in the vehicle in order to alert the operator. A request for additional information may be sent to the vehicle. For example, the operator may be given some leeway in determining if the roadway conditions are severe enough. Vehicle sensors may report that the roadway has poor traction, a condition that may be verified or contested by an operator or vehicle sensor. Action messages may be transmitted ahead of time, during which the conditions may change. For a lightly trafficked roadway, a community based sensor network may not receive many reports. An action message transmitted that was not complied with, may be ignored if the conditions have changed.

If a user does not acknowledge the alert, or the vehicle has not complied, the alert or order can continue to be re-sent until a user acknowledgement or vehicle compliance has been sent in reply. Depending on the severity of a hazard, the alert may be sent, for example, every 30 seconds, every minute, every 10 minutes, and so on. The alert may be textual, visual, or auditory. A personal navigation system or display in the vehicle may be used to display a text message describing the alert. A visual display such as a blinking symbol may be used. An auditory alert such as a bell or ring tone may be used to indicate an alert.

In the event that compliance is not verified, the system may transmit an alert message to a responsible party. Depending on the regulation, the responsible party may be, for example, the local police or a trucking company. An alert may be transmitted to stations along the route the truck is travelling or expected to travel. A road authority or law enforcement may take further action according to the requirements and laws. An alert may be transmitted to a different device, for example, a personal cellphone or mobile device of the operator.

In an embodiment, a unique code may be transmitted to the vehicle that indicates that the vehicle is in compliance with the regulation. The code may be locally broadcast by the vehicle as the vehicle passes by sensors on the roadway. Using the code, a vehicle may not have to pull off at truck stations. The code may also allow road authorities or law enforcement a quick and efficient method of determining if a vehicle is in compliance, without knowing the specifics of the regulation or attributes of the vehicle. The regulations may thus be flexible without confounding enforcement. A vehicle that is not in compliance may not be provided with the code or may be provided with a code that specifies any infractions.

In an embodiment, compliance with regulations may be monitored for vehicle platooning service. Platooning regulations may be different than typical regulations. A speed of a platoon, or linked convoy of two or more vehicle may be regulated differently for different regions and roadway conditions. Regulations may include when and where platoons are allowed by law, which types of vehicles can join particular platoon under what conditions (fleet/make/model/routes or destinations/load type/hazmat or not), automation capabilities in the platoon and any requirements for automation, when and where a vehicle can or must exit a platoon, energy characteristics, and/or when and where a vehicle can join a platoon.

FIG. 6 illustrates an example server 125 of the system of FIG. 1. The server 125 includes a processor 800 that is connected to a communications interface 805 and a memory 801. The processor 800 is also connected to the geographic database 123. The communications interface 805 is configured to receive vehicle data from a vehicle. The memory 801 is configured to store regulatory, roadway condition, and vehicle data. The processor 800 is configured to analyze the position of a vehicle, roadway conditions, and attributes of the vehicle to determine if the vehicle is in compliance with active regulations. The processor 800 may be configured to generate maps and routing instructions. Additional, different, or fewer components may be included.

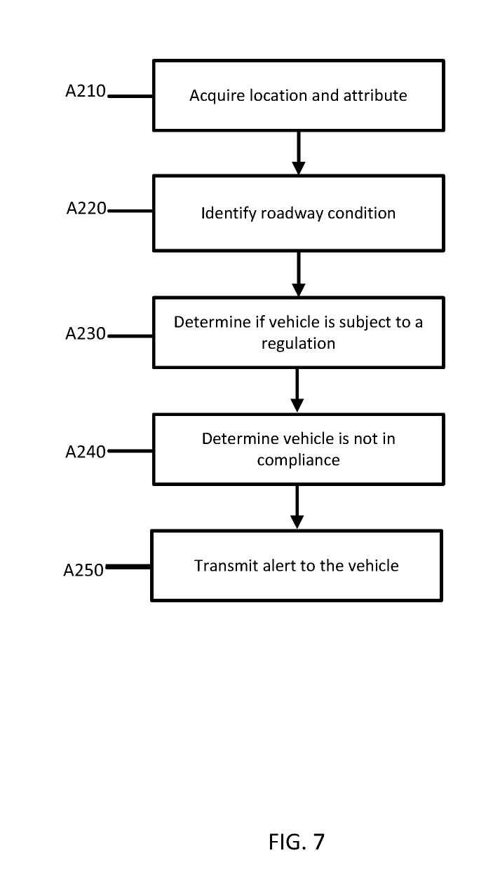

FIG. 7 depicts an example method for monitoring compliance with a roadway regulation using the server 125 of FIG. 1. As presented in the following sections, the acts may be performed using any combination of the components indicated in FIG. 1, FIG. 6, or FIG. 9. The following acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A210, the processor 800 receives first vehicle data relating to operation of a vehicle and a location of the vehicle using the communications interface 805. The first vehicle data may include attributes of the vehicle such as the dimension, weight, or operational capabilities of the vehicle. The first vehicle data may include data relating to the operation of the vehicle such as speed, traction, braking, or environmental data. The position data may be the location of the vehicle described using geographic coordinates such as latitude and longitude or a roadway segment or node.

The processor 800 may include a general processor, digital signal processor, an application specific integrated circuit (ASIC), field programmable gate array (FPGA), analog circuit, digital circuit, combinations thereof, or other now known or later developed processor. The processor 800 may be a single device or combinations of devices, such as associated with a network, distributed processing, or cloud computing.

The communications interface 805 may include any operable connection. An operable connection may be one in which signals, physical communications, and/or logical communications may be sent and/or received. An operable connection may include a physical interface, an electrical interface, and/or a data interface. The communication interface 805 provides for wireless and/or wired communications in any now known or later developed format. The communication interface 805 may include a receiver/transmitter for digital radio signals or broadcast mediums.

At act A220, the processor 800 identifies a roadway condition for the location. Example roadway conditions may include environmental conditions, a road surface type, a road surface temperature, visibility, precipitation (and amount), and light conditions among others. Roadway conditions may cover regions or individual nodes or road segments. Data for the roadway conditions may be stored in the memory or geographic database 123. Roadway condition data may be acquired by a community based sensor network, for example, by collecting data from multiple vehicles or roadway sensors.

At act A230, the processor 800 determines that the vehicle is subject to the roadway regulation based on the location of the vehicle and the roadway conditions. Regulations may be propagated and maintained by an authority. The authority may be a governmental agency or other agency that is empowered to give orders, make decisions, or enforce obedience. For example, a trucking company or shipping company may be considered an authority even though any rules prorogated and enforced by the company may not apply to the general public. Regulations may relate to operation of a vehicle on a roadway. Regulations may only apply to certain vehicles depending on attributes of the vehicle. For example, certain regulations may only apply to vehicles that exceed certain attributes such as weight or loads. Regulations may apply at specific times to vehicles based on vehicle attributes, roadway conditions, and vehicle operation. Regulations may be based on an algorithmic equation with inputs such as the attributes or roadway conditions.

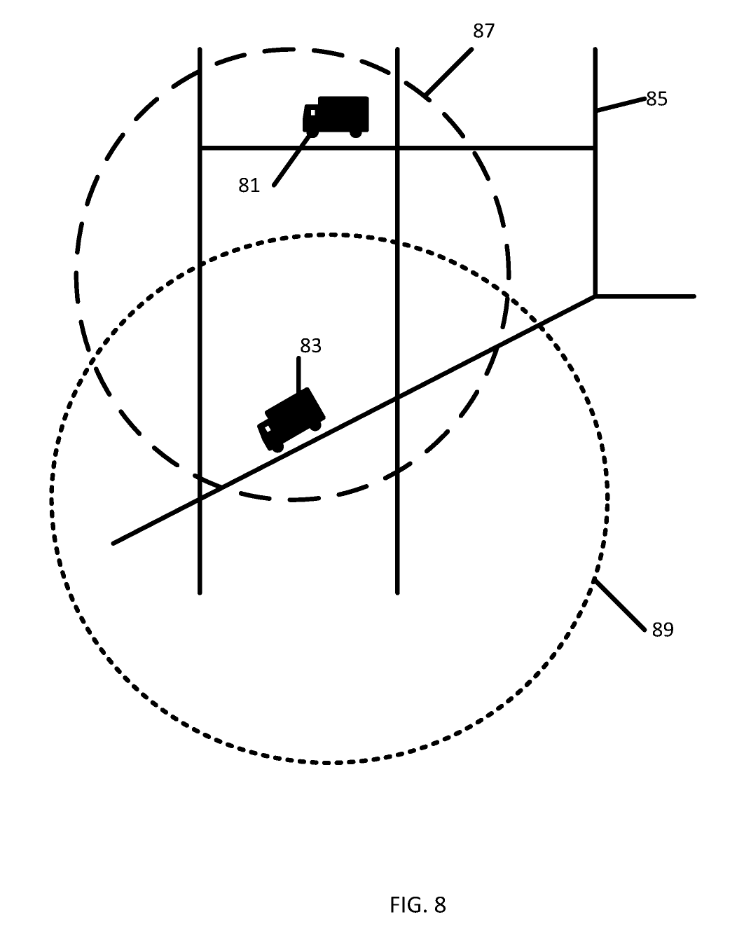

FIG. 8 depicts an example of a determination that a vehicle is subject to a roadway regulation. FIG. 8 depicts two vehicles 81, 83 traveling a roadway network 85. A regulation covers an area 87 of the roadway network. A roadway condition exists for the area 89. The processor 800 determines based on the location of the vehicles 81, 83 and the roadway conditions if the vehicles 81, 83 are subject to the roadway regulation 87. While both vehicles are located within the area covered by the roadway regulation 87, Vehicle 81 is not subject to the regulation 87 as vehicle 81 is not affected by the roadway condition 89. Vehicle 83 is subject to the regulation as the location of vehicle 83 places the vehicle 83 in the area that is affected by the roadway condition 89.

At act A240, the processor 800 determines that the vehicle is not in compliance with the roadway regulation based on the first vehicle data. The first vehicle data may include attributes of the vehicle. The roadway regulation may include one or more conditions to be satisfied before the regulation is applied. For example, the regulation may only apply to vehicles having a weight of over 8,000 lbs. or a length over 30 meters. As depicted in FIG. 8 above, each vehicle 81, 83 may have different attributes such as weight or height. Whether or not a regulation applies may depend on several factors such as the roadway conditions, the attributes of the vehicle, the operation of the vehicle, and/or the history of operation of the vehicle among other inputs. Certain regulations may apply differently for autonomous vehicles or semi-autonomous vehicles. Certain regulations may apply differently based on the ability of the vehicle to traverse hazardous terrain, for example, depending on brake systems or traction.

At act A250, the processor 800 transmits an alert to the vehicle. The alert may include one or more actions for the vehicle to perform. In an example for a regulation for a traction apparatus, a traction activation alert may be transmitted and received by any connected network, e.g., a digital transportation infrastructure system, and processed by an onboard system of a vehicle to either alert a driver/user and/or optionally automatically deploy or implement an action relating to traction. The processor 800 may receive vehicle data from the vehicle or other sensor that acknowledges that the vehicle has performed an appropriate action in order to be compliant with the regulation. If the processor 800 does not receive verification data from the vehicle, the processor 800 may repeat steps A240 and A250, retransmitting the alert to the vehicle. The acknowledgement may automatically be sent back to the processor 800 or authority or mapping system 121. The acknowledgement may verify that the user has acknowledged the alert and/or that a particular vehicle has complied with the activation order. If a user does not acknowledge the alert, or the vehicle has not complied, the alert or order may continue to be re-sent until a user acknowledgement or vehicle compliance has been sent in reply. After a period of time or number of failures to acknowledge, further actions may be taken by a road authority or law enforcement according to the requirements and laws.

In an embodiment, the processor 800 may calculate an alternative route for the vehicle. The processor 800 may identify a regulation that the vehicle may not be able to comply with. The processor 800 may identify road segments with no regulations or regulations that the vehicle may be able to comply with. The processor 800 may use a starting location (or current location) of the vehicle and destination to determine a route.

FIG. 9 illustrates an example device 122 of the system of FIG. 1. The device 122 may be configured to collect, transmit, receive, process, or display data. The device 122 may also be referred to as a probe 122, a mobile device 122 or a navigation device 122. The device 122 includes a controller 811, a memory 817, an input device 813, a communication interface 815, position circuitry 819, and an output interface 821. The output interface 821 may present visual or non-visual information such as audio information. Additional, different, or fewer components are possible for the mobile device 122. The device 122 may be smart phone, a mobile phone, a personal digital assistant (PDA), a tablet computer, a notebook computer, a personal navigation device (PND), a portable navigation device, and/or any other known or later developed mobile device. In an embodiment, a vehicle may be considered a device 122, or the device 122 may be integrated into a vehicle. The device 122 may receive or collect data from one or more sensors in or on the vehicle.

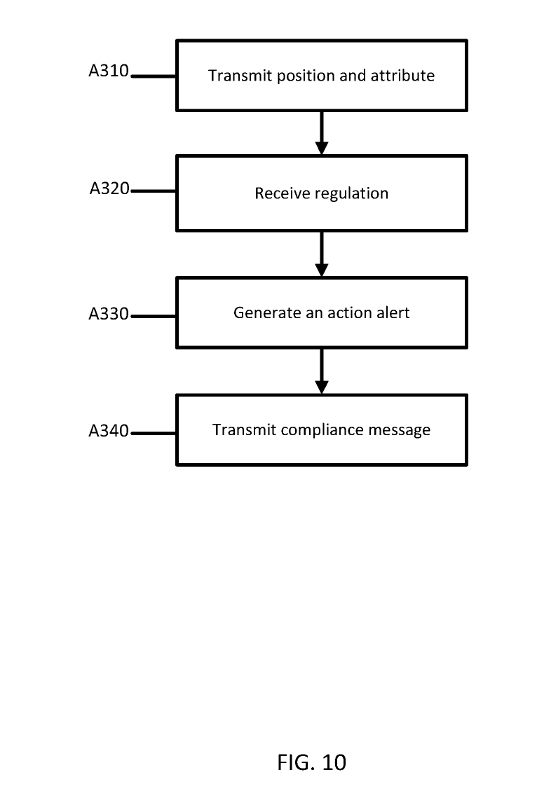

FIG. 10 illustrates an example flow chart for providing verification of compliance with a regulation. As presented in the following sections, the acts may be performed using any combination of the components indicated in FIG. 1, FIG. 6, or FIG. 9. The following acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A310, the device 122 transmits data including a position of the device and one or more attributes of the device 122. The position of the device may be input by an operator or identified using positional circuitry. A user may specify a location or route. For a route, the starting location and destination may be input though the input device 813. For example, a user may request a route to a destination using the input device 813. The location of the device 122 may be monitored by positional circuitry 819. The input device 813 may be one or more buttons, keypad, keyboard, mouse, stylus pen, trackball, rocker switch, touch pad, voice recognition circuit, or other device or component for inputting data to the mobile device 122. The input device 813 and the output interface 821 may be combined as a touch screen that may be capacitive or resistive.

The starting location or a current location of the device (and as such, vehicle) may be identified using positional circuitry 819 such as GPS or other positional inputs. The positioning circuitry 819, which is an example of a positioning system, is configured to determine a geographic position of the device 122. The positioning circuitry 819 may include movement circuitry, which is an example a movement tracking system, is configured to determine movement of a device 122. The position circuitry 819 and the movement circuitry may be separate systems, or segments of the same positioning or movement circuitry system. In an embodiment, components as described herein with respect to the navigation device 122 may be implemented as a static device. For example, such a device may not include movement circuitry 819, but may involve a speed or velocity detecting input device 813. The device 122 may identify its position as the device travels along a route using the positional circuitry. For indoor spaces without GPS signals, the navigation device 122 may rely on other geolocation methods such as LIDAR, radar, Wi-Fi, beacons, landmark identification, inertial navigation (dead reckoning), among others.

The device 122 may be configured to receive data from one or more vehicular sensors. The one or more devices 122 may acquire data relating to the operation of the vehicle by monitoring sensors in the vehicle. For example, the speed, acceleration, position, and braking systems among other systems may be monitored. Other data such as steering data, network connection data, object recognition, lane recognition, and environmental data may be monitored.

The device 122 may be configured to execute routing algorithms using a geographic database 123 to determine a route to travel along a road network from a starting location to a destination location in a geographic region. Using input from an end user, the device 122 examines potential routes between the origin location and the destination location to determine the optimum route in light of user preferences. The device may use as an input, one or more regulations in force in the region. The device may request information or may determine based on current roadway conditions and vehicle attributes whether the vehicle associated with the device 122 is capable of compliance with the regulations. The device 122 may then provide the end user with information about the optimum route in the form of guidance that identifies the maneuvers required to be taken by the end user to travel from the origin to the destination location. Some devices 122 show detailed maps on displays outlining the route, the types of maneuvers to be taken at various locations along the route, locations of certain types of features, and so on. The device 122 may provide visual indicators of regulations that apply to the vehicle.

At act A320, the device 122 receives a regulatory alert. In one embodiment, the device may determine if the device needs to comply with the regulatory alert, e.g., based upon vehicle type, weight, hazmat or load types, route, surface condition, external surface treatment status, installed tire types, type of tire preparations (e.g. chain, stud, spike), and onboard surface/tire treatment capabilities. The device may receive information with the regulatory alert that relates to roadway conditions such as environmental conditions or traffic conditions. In an embodiment, the device 122 may receive commands or instructions on how to comply with the regulation. In an example for a regulation relating to a traction apparatus, the device may be informed by real-time parking availability information provided by a mapping server 121. The information may provide a location for the vehicle to park for the purpose of installing a traction apparatus or waiting out the activation law time. Data relating to the attributes of a vehicle and roadway conditions may be stored in the memory, and may be updated by vehicle sensors or communications with the mapping system 121 or other connected devices.

The memory 817 may be a volatile memory or a non-volatile memory. The memory 817 may include one or more of a read only memory (ROM), random access memory (RAM), a flash memory, an electronic erasable program read only memory (EEPROM), or other type of memory. The memory 817 may be removable from the mobile device 122, such as a secure digital (SD) memory card. The memory may contain a locally stored geographic database or link node routing graph. The locally stored geographic database may be a copy of the geographic database 123 or may include a smaller piece. The locally stored geographic database may use the same formatting and scheme as the geographic database.

At act A330, the device 122 generates an action alert. The device may generate a textual, auditory, or visual alert with information that relates to the regulatory alert and an action. For example, an alert may be provided to a user by the output interface 821. The output interface 821 may be a liquid crystal display (LCD) panel, light emitting diode (LED) screen, thin film transistor screen, or another type of display. The output interface 821 may also include audio capabilities, or speakers.

At act A340, the device 122 transmits compliance data related to the action using the communications interface 815. An acknowledgement can automatically be sent back to the issuing authority (e.g. compliance server) that the user has acknowledged the alert, and furthermore that a particular vehicle has complied with the regulatory alert. If a user does not acknowledge the alert, or the vehicle has not complied, the alert or order can continue to be re-sent until a user acknowledgement or vehicle compliance has been sent in reply. Further actions can be taken by the road authority or law enforcement according to the requirements and laws.

The communications interface 815 may include any operable connection. An operable connection may be one in which signals, physical communications, and/or logical communications may be sent and/or received. An operable connection may include a physical interface, an electrical interface, and/or a data interface. The communication interface 815 provides for wireless and/or wired communications in any now known or later developed format. The communication interface 815 may include a receiver/transmitter for digital radio signals or other broadcast mediums.

The device 122 may be integrated into an autonomous vehicle or a highly-assisted or highly-automated driving (HAD) vehicle. The device 122 may be configured as a navigation system for an autonomous vehicle or a HAD. An autonomous vehicle or HAD may take route instruction based on the link and node information provided to the navigation device 122. An autonomous vehicle or HAD may be configured to receive regulatory alerts from a mapping system 121, automatically perform an action, and transmit data back to the mapping system 121 indicating compliance (or non-compliance).

The mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle. The assisted driving device may include memory, a processor, and systems to communicate with the mobile device 122. The assisted driving vehicles may response to geographic data received from geographic database 123 and the server 125, which may have been updated.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order to pass the initial observation location or road object in response to the request for additional observations.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and the request for additional observations for the road object.

A HAD or ADAS may be configured to automatically comply with regulations. A HAD or ADAS may receive regulation data from an authority and automatically perform an action in order to comply with the regulation. The HAD or ADAS may transmit data relating to the action to the authority to verify compliance. A HAD or ADAS may determine when the vehicle is not in compliance and may alert an operator or perform an action such as reducing speed or pulling off to the side of the road.

ADAS vehicles include one or more partially automated systems in which the vehicle alerts the driver. The features may be used to provide alerts to the operator regarding compliance with regulations. Features may include adaptive cruise control, automated braking, or steering adjustments to keep the driver in the correct lane. ADAS vehicles may issue warnings for the driver based on the position of the vehicle either on a roadway or within a road network system.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in the specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

The following embodiments are disclosed.

### Embodiment 1

A method for monitoring compliance with a regulation for a vehicle, the method comprising: acquiring, by a processor, a position of the vehicle and a roadway condition; identifying, by the processor, one or more attributes of the vehicle; determining, by the processor, if the regulation applies to the vehicle based on the position, the roadway condition, and the one or more attributes; transmitting, by the processor, to the vehicle, a command to perform an action relating to the regulation; receiving, by the processor, first vehicle data relating to the action from the vehicle; and determining, by the processor, based on the first vehicle data, if the action has been complied with.

### Embodiment 2

the method of embodiment 1, further comprising: transmitting, by the processor, when action is not complied with, a first alert to the vehicle; receiving by the processor, second vehicle data relating to the action from the vehicle; and determining, by the processor, based on the second vehicle data, if the vehicle is in compliance with the regulation.

### Embodiment 3

the method of embodiment 2, further comprising: transmitting, by the processor, an alert to a local responsible authority when the vehicle is determined based on the second vehicle data to not be in compliance with the regulation.

### Embodiment 4

the method of embodiment 1, wherein the one or more attributes comprise a weight of the vehicle.

### Embodiment 5

the method of embodiment 1, wherein the one or more attributes comprise a height of the vehicle.

### Embodiment 6

the method of embodiment 1, wherein the regulation relates to a traction apparatus and the action is to install the traction apparatus.

### Embodiment 7

the method of embodiment 6, wherein the first data is received a first time after transmitting the command; wherein the first time comprises a length of time for the vehicle to travel to a location and install the traction apparatus.

### Embodiment 8

the method of embodiment 1, wherein the regulation relates to tire studs and the action is to automatically deploy tire studs on the vehicle.

### Embodiment 9

the method of embodiment 1, further comprising: storing compliance data relating to whether the action has been complied with in a database.

### Embodiment 10

a method for monitoring compliance with a roadway regulation, the method comprising: receiving first vehicle data relating to operation of a vehicle and a location of the vehicle; identifying a roadway condition for the location; determining, using a processor, that the vehicle is subject to the roadway regulation based on the roadway condition and the location of the vehicle; determining that the vehicle is not in compliance with the roadway regulation based on the first vehicle data; and transmitting an alert to the vehicle.

### Embodiment 11

the method of embodiment 10, further comprising: identifying one or more attributes of the vehicle; wherein determining that the vehicle is subject to the roadway regulation is further based on the one or more attributes.

### Embodiment 12

the method of embodiment 10, further comprising: receiving second vehicle data from the vehicle describing updated operation of the vehicle; and determining that the vehicle is in compliance with the roadway regulation based on the second vehicle data.

### Embodiment 13

the method of embodiment 12, wherein the alert is retransmitted until compliance is determined.

### Embodiment 14

the method of embodiment 12, further comprising: transmitting a message to an authority when the vehicle is determined to not be in compliance.

### Embodiment 15

an apparatus for providing compliance with a regulation, the apparatus comprising: positional circuitry configured to determine a location of a vehicle; a geographic database configured to store data related to a roadway condition for the location; a vehicle sensor configured to identify one or more attributes of the vehicle; a transceiver configured to receive a regulation from an authority and transmit a compliance message to the authority; and a processor configured to determine if the regulation applies to the vehicle based on the location, roadway condition, and the one or more attributes, perform an action to comply with the regulation, and generate the compliance message.

### Embodiment 16

the apparatus of embodiment 15, further comprising: a display configured to display an alert message to an operator of the vehicle describing the regulation and action.

### Embodiment 17

the apparatus of embodiment 15, wherein the regulation requires tire chains when the roadway condition exceeds a level of precipitation on a roadway segment.

### Embodiment 18

the apparatus of embodiment 17, wherein the regulation further requires tire chains when an attribute of the vehicle exceeds a predetermined level.

### Embodiment 19

the apparatus of embodiment 17, wherein the action comprises stopping at location described in the regulation.

### Embodiment 20

the apparatus of embodiment 17, wherein the vehicle is an autonomous vehicle and the action is performed automatically.

We claim:

1. A method for monitoring compliance with a regulation for a vehicle, the method comprising:
acquiring, by a processor, a position of the vehicle and a roadway condition;
identifying, by the processor, one or more attributes of the vehicle;
determining, by the processor, if the regulation applies to the vehicle based on the position, the roadway condition, and the one or more attributes;
transmitting, by the processor, to the vehicle, a command to perform an action relating to the regulation;
receiving, by the processor, first vehicle data relating to the action from the vehicle; and
determining, by the processor, based on the first vehicle data, if the action has been complied with.

2. The method of claim 1, further comprising:
transmitting, by the processor, when action is not complied with, a first alert to the vehicle;
receiving by the processor, second vehicle data relating to the action from the vehicle; and
determining, by the processor, based on the second vehicle data, if the vehicle is in compliance with the regulation.

3. The method of claim 2, further comprising:
transmitting, by the processor, an alert to a local responsible authority when the vehicle is determined based on the second vehicle data to not be in compliance with the regulation.

4. The method of claim 1, wherein the one or more attributes comprise a weight of the vehicle.

5. The method of claim 1, wherein the one or more attributes comprise a height of the vehicle.

6. The method of claim 1, wherein the regulation relates to a traction apparatus and the action is to install the traction apparatus.

7. The method of claim 6, wherein the first data is received a first time after transmitting the command; wherein the first time comprises a length of time for the vehicle to travel to a location and install the traction apparatus.

8. The method of claim 1, wherein the regulation relates to tire studs and the action is to automatically deploy tire studs on the vehicle.

9. The method of claim 1, further comprising:
storing compliance data relating to whether the action has been complied with in a database.

10. A method for monitoring compliance with a roadway regulation, the method comprising:
receiving first vehicle data relating to operation of a vehicle and a location of the vehicle;
identifying a roadway condition for the location;
determining, using a processor, that the vehicle is subject to the roadway regulation based on the roadway condition and the location of the vehicle;
determining that the vehicle is not in compliance with the roadway regulation based on the first vehicle data; and
transmitting an alert to the vehicle.

11. The method of claim 10, further comprising:
identifying one or more attributes of the vehicle; wherein determining that the vehicle is subject to the roadway regulation is further based on the one or more attributes.

12. The method of claim 10, further comprising:
receiving second vehicle data from the vehicle describing updated operation of the vehicle; and
determining that the vehicle is in compliance with the roadway regulation based on the second vehicle data.

13. The method of claim 12, wherein the alert is retransmitted until compliance is determined.

14. The method of claim 12, further comprising:
transmitting a message to an authority when the vehicle is determined to not be in compliance.

15. An apparatus for providing compliance with a regulation, the apparatus comprising:
positional circuitry configured to determine a location of a vehicle;
a geographic database configured to store data related to a roadway condition for the location;
a vehicle sensor configured to identify one or more attributes of the vehicle;
a transceiver configured to receive a regulation from an authority and transmit a compliance message to the authority; and
a processor configured to determine if the regulation applies to the vehicle based on the location, roadway condition, and the one or more attributes, perform an action to comply with the regulation, and generate the compliance message.

16. The apparatus of claim 15, further comprising:
a display configured to display an alert message to an operator of the vehicle describing the regulation and action.

17. The apparatus of claim 15, wherein the regulation requires tire chains when the roadway condition exceeds a level of precipitation on a roadway segment.

18. The apparatus of claim 17, wherein the regulation further requires tire chains when an attribute of the vehicle exceeds a predetermined level.

19. The apparatus of claim 17, wherein the action comprises stopping at location described in the regulation.

20. The apparatus of claim 17, wherein the vehicle is an autonomous vehicle and the action is performed automatically.
